(19) United States
(12) Patent Application Publication
(10) Pub. No.: US 2013/0225464 A1
(43) Pub. Date: Aug. 29, 2013

(54) CLEANING LIQUID FOR SEMICONDUCTOR DEVICE SUBSTRATES AND CLEANING METHOD

(71) Applicant: MITSUBISHI CHEMICAL CORPORATION, (US)

(72) Inventors: Ken HARADA, Fukuoka (JP); Atsushi Ito, Fukuoka (JP); Toshiyuki Suzuki, Fukuoka (JP)

(73) Assignee: MITSUBISHI CHEMICAL CORPORATION, Chiyoda-ku (JP)

(21) Appl. No.: 13/854,235

(22) Filed: Apr. 1, 2013

Related U.S. Application Data
(63) Continuation of application No. PCT/JP2011/072466, filed on Sep. 29, 2011.

(30) Foreign Application Priority Data
Oct. 1, 2010 (JP) 2010-224124

(51) Int. Cl. C11D 3/37; C11D 1/22; C11D 3/20

(52) U.S. Cl. CPC C11D 3/3776; C11D 3/2086; C11D 1/22; C11D 3/3707
USPC 510/175

(57) ABSTRACT

The invention relates to a cleaning liquid for semiconductor device substrates, which is for use in a step of cleaning a semiconductor device substrate to be conducted after a chemical mechanical polishing step in semiconductor device production, the cleaning liquid including the following components (A) to (D):
(A) an organic acid;
(B) a sulfonic acid type anionic surfactant;
(C) at least one polymeric coagulant selected from polyvinylpyrrolidone and polyethylene oxide-polypropylene oxide block copolymers; and
(D) water.

### TECHNICAL FIELD

The present invention relates to a cleaning liquid for effectively cleaning a surface of a substrate for semiconductor devices.

### BACKGROUND ART

In semiconductor device production steps, new metallic materials having a low resistance value (Cu, etc.) and low-dielectric constant (Low-k) materials are coming to be employed as wiring and interlayer insulating film, respectively, in order to attain increases in speed and integration degree in the devices.

A substrate for semiconductor devices is produced by first forming deposit layers including a metal film and an interlayer insulating film on a silicon wafer substrate, subsequently subjecting the wafer substrate to chemical mechanical polishing (hereinafter referred to as “CMP”) to conduct surface planarization, and stacking new layers on the planarized surface. In the substrate for semiconductor devices, each layer must be highly precisely planar.

On the surface of the semiconductor device substrate which has undergone the CMP step, various foreign matters remain. For example, the foreign matters include dust particles resulting from the polishing of the metallic wiring or low-dielectric constant film, colloidal silica contained in the slurry used in the CMP step, and organic residues derived from the anticorrosive contained in the slurry. For producing a semiconductor device having a multilayer structure, it is essential to remove such foreign matters. However, there are problems such as the following. The low-dielectric constant film is difficult to clean because the low-dielectric constant film is hydrophobic, has a low affinity for water, and repels the cleaning liquid. Furthermore, the colloidal silica is as extremely small as 100 nm or below and hence is difficult to remove. Although the organic residues can be dissolved away or decomposed, use of a cleaning liquid which has high dissolving or decomposing ability corrodes of the metallic wiring. In order to overcome these problems, application of various cleaning techniques is being attempted.

An important technique among these is to control zeta potential. It is known that in acidic water, the surface of a semiconductor device substrate into which copper wiring has been introduced is negatively charged. Meanwhile, it is known that the colloidal silica contained in the slurry which is in use in the CMP step is positively charged in acidic water. In the case where the cleaning liquid contains no anionic surfactant, the fine colloidal silica particles which have been positively charged are apt to adhere to the negatively charged surface of the semiconductor device substrate in the substrate cleaning step that is conducted subsequently to the CMP step. For preventing this adhesion, it is necessary to control the zeta potential of the colloidal silica so as to be negative.

In addition, the substrate cleaning step, which is conducted subsequently to the CMP step, is further required to be less apt to cause corrosion of the Cu wiring. Since the degree of integration in devices is becoming higher and the Cu wiring is becoming thinner especially in recent years, there are cases where even slight corrosion which was not problematic in conventional devices can be a cause of a decrease in yield.

In order to overcome such a problem, application of various cleaning techniques is being attempted.

For example, in patent document 1, a cleaning liquid obtained by adding an alkali or an organic acid to a specific surfactant and water is disclosed in order to remove fine particles and organic contaminants which have adhered to a substrate.

In patent document 2, a cleaning liquid which contains a nonionic surfactant, e.g., polyoxyethylene nonylphenyl ether, a compound that forms a complex with a metal, such as aminoacetic acid or quinaldinic acid and an alkali ingredient is disclosed.

### BACKGROUND ART DOCUMENT

### Patent Document

Patent Document 1: JP-A-2003-289060

Patent Document 2: JP-A-2002-270566

### SUMMARY OF INVENTION

### Problem that Invention is to Solve

Various cleaning methods have been proposed as techniques for use in semiconductor device production steps. However, the conventional art techniques have had problems, for example, that the substrate-cleaning effect of the cleaning liquid is insufficient, that the cleaning liquid corrodes the substrate surface (in particular, the metallic wiring), and that the cleaning liquid is less apt to be removed in the step of rinsing with ultrapure water, resulting in the necessity of a prolonged rinsing period, which constitutes an obstacle to a reduction in cleaning period.

There has been no technique capable of sufficiently removing, in a short period, various contaminants present on the surface of, in particular, a hydrophobic low-dielectric constant insulating film or highly corrodible Cu wiring. There has been a need for establishing such technique.

An object of the invention, which has been accomplished in order to eliminate the problems described above, is to provide a cleaning liquid for semiconductor device substrates which is capable of simultaneously removing contaminants due to fine-particle adhesion, organic contaminants and metallic contaminants without corroding the substrate surface, and which has satisfactory water rinsability and can highly clean the substrate surface in a short period.

### Means for Solving Problem

The present inventors thought that for effectively inhibiting fine particles having a particle diameter of about 100 nm or smaller from contaminating the surface of a hydrophobic low-dielectric constant insulating film, it was important to improve the wettability of the hydrophobic surface by utilizing a surfactant and to coagulate such fine particles to lower the adsorbability thereof. The inventors diligently made investigations in order to overcome the problems described above. As a result, the inventors have found that those problems can be eliminated when a solution which contains a specific surfactant and a specific polymeric coagulant is used as a cleaning liquid. The invention has been thus accomplished.

The present invention relates to the following inventions.

<1> A cleaning liquid for semiconductor device substrates, which is for use in a step of cleaning a semiconductor device substrate to be conducted after a chemical mechanical polishing step in semiconductor device production, the cleaning liquid comprising the following components (A) to (D):

(A) an organic acid;

(B) a sulfonic acid type anionic surfactant;

(C) at least one polymeric coagulant selected from polyvinylpyrrolidone and polyethylene oxide-polypropylene oxide block copolymers; and

(D) water.

<2> The cleaning liquid for semiconductor device substrates as described in <1> above,

wherein component (A) is an organic acid having 1 to 10 carbon atoms and one or more carboxyl groups.

<3> The cleaning liquid for semiconductor device substrates as described in <2> above,

wherein component (A) is at least one member selected from the group consisting of oxalic acid, citric acid, tartaric acid, malic acid, lactic acid, ascorbic acid, gallic acid and acetic acid.

<4> The cleaning liquid for semiconductor device substrates as described in any one of <1> to <3> above,

wherein component (B) is at least one member selected from the group consisting of alkylsulfonic acids and salts thereof, alkylbenzenesulfonic acids and salts thereof, alkyldiphenyl ether disulfonic acids and salts thereof, alkylmethyltauric acids and salts thereof, and sulfosuccinic acid diesters and salts thereof.

<5> The cleaning liquid for semiconductor device substrates as described in any one of <1> to <4> above,

wherein component (A) is contained in a concentration of 5 to 30% by mass,

component (B) is contained in a concentration of 0.01 to 10% by mass, and

component (C) is contained in a concentration of 0.001 to 10% by mass.

<6> The cleaning liquid for semiconductor device substrates as described in any one of <1> to <4> above,

wherein component (C) is polyvinylpyrrolidone,

component (A) is contained in a concentration of 0.03 to 3% by mass,

component (B) is contained in a concentration of 0.0001 to 1% by mass, and

component (C) is contained in a concentration of 0.00001 to 0.003% by mass.

<7> The cleaning liquid for semiconductor device substrates as described in any one of <1> to <4> above,

wherein component (C) is a polyethylene oxide-polypropylene oxide block copolymer,

component (A) is contained in a concentration of 0.03 to 3% by mass,

component (B) is contained in a concentration of 0.0001 to 1% by mass, and

component (C) is contained in a concentration of 0.00001 to 0.03% by mass.

<8> The cleaning liquid for semiconductor device substrates as described in any one of <1> to <4>, <6> and <7> above,

wherein colloidal silica having a primary-particle diameter of 80 nm has a zeta potential of −20 mV or lower as measured in a liquid prepared by diluting the cleaning liquid to a water/cleaning liquid ratio of 40 by mass.

<9> A method of cleaning a substrate for semiconductor devices, comprising:

cleaning the substrate for semiconductor devices by using the cleaning liquid for semiconductor device substrates as described in any one of <1> to <4> and <6> to <8> above.

<10> The method of cleaning a substrate for semiconductor devices as described in <9> above,

wherein the substrate for semiconductor devices has Cu wiring and a low-dielectric constant insulating film on a substrate surface, and

the substrate for semiconductor devices that has been subjected to chemical mechanical polishing is cleaned.

### Effects of Invention

According to the invention, a cleaning liquid for semiconductor device substrates is provided with which it is possible, in the cleaning of a substrate for semiconductor devices, to simultaneously remove the fine particles, organic contaminants, and metallic contaminants that are adherent to the substrate, without corroding the substrate surface, and which has satisfactory water rinsability.

### MODE FOR CARRYING OUT INVENTION

The present invention is explained below in detail. In the invention, “% by mass” has the same meaning as “% by weight”.

The present invention relates to a cleaning liquid for semiconductor device substrates, which is for use in a step of cleaning a semiconductor device substrate to be conducted after a chemical mechanical polishing step in semiconductor device production, the cleaning liquid including the following components (A) to (D):

(A) an organic acid;

(B) a sulfonic acid type anionic surfactant;

(C) at least one polymeric coagulant selected from polyvinylpyrrolidone and polyethylene oxide-polypropylene oxide block copolymers; and

(D) water.

In the invention, the term organic acid is used as a general term for organic compounds which are acidic (pH<7) in water. The organic acid as component (A) represents an organic compound which has an acidic functional group, e.g., a carboxyl group (—COOH), a sulfo group (—SO₃H), a phenolic hydroxyl group (—ArOH; Ar is an aryl group, e.g., phenyl group), or a mercapto group (—SH).

The organic acid to be used in the invention is not particularly limited. However, carboxylic acids which have 1 to 10 carbon atoms and one or more carboxyl groups are preferred. More preferred are carboxylic acids having 1 to 8 carbon atoms. Even more preferred are carboxylic acids having 1 to 6 carbon atoms.

The carboxylic acids may be any carboxylic acids having one or more carboxyl groups, and a monocarboxylic acid, a dicarboxylic acid, a tricarboxylic acid, or the like can be suitably used. Carboxylic acids which contain a functional group other than a carboxyl group, such as, for example, oxycarboxylic acids or aminocarboxylic acids, may also be used.

Especially preferred examples among these include oxalic acid, citric acid, tartaric acid, malic acid, lactic acid, ascorbic acid, gallic acid and acetic acid.

One of these organic acids may be used alone, or two or more thereof may be used in combination in any desired proportion. Furthermore, an acidic salt of a polyvalent organic acid can also be used as component (A).

As component (B), i.e., a sulfonic acid type anionic surfactant, use can be made of any anionic surfactant having a sulfo group (—SO₃H). However, preferred are alkylsulfonic acids and salts thereof, alkylbenzenesulfonic acids and salts thereof, alkyldiphenyl ether disulfonic acids and salts thereof, alkylmethyltauric acids and salts thereof, and sulfosuccinic acid diesters and salts thereof.

More preferred examples thereof include dodecylbenzenesulfonic acid, dodecanesulfonic acid and alkali metal salts of these acids.

Of these, dodecylbenzenesulfonic acid and alkali metal salts thereof are suitable from the standpoints of quality stability and availability.

One of such compounds may be used alone as component (B), or two or more of such compounds may be used as component (B) in any desired proportion.

The polymeric coagulant as component (C) is a water-soluble polymer which functions as a coagulant, and is at least one of polyvinylpyrrolidone and polyethylene oxide-polypropylene oxide block copolymers. One of these polymers may be used alone as component (C), or two or more thereof may be used in combination as component (C) in any desired proportion.

The polyvinylpyrrolidone (hereinafter referred to as “PVP”) is a polymer of N-vinyl-2-pyrrolidone, and polyvinylpyrrolidone having a number-average molecular weight of about 5,000 to 50,000 is suitable for use. With respect to the polyethylene oxide-polypropylene oxide block copolymers (hereinafter referred to as “EO/PO copolymers”), which are represented by the rational formula [—(CH₂CH₂O-)m(-C₃H₆O-)n] (wherein m and n represent a positive number; the molecule may contain a plurality of blocks which differ in chain length), the copolymers having a weight-average molecular weight of about 5,000 to 50,000 are suitable for use.

The water used as component (D) is the solvent of the cleaning liquid of the invention. It is preferred that the water to be used as a solvent should be either deionized water in which the content of impurities has been minimized or ultrapure water. Component (D) may contain a solvent other than water, such as, for example, ethanol, so long as the inclusion thereof does not lessen the effects of the invention.

Also with respect to components (A) to (C) and other additives, it is preferred to use purified ingredients according to need.

When a cleaning liquid which contains component (A) and component (B) is used, electrical repulsion is caused between the fine particles, e.g., colloidal silica, contained in the slurry used in the CMP step and the surface of the semiconductor device substrate and the fine particles, e.g., colloidal silica, become less apt to adhere to the surface of the semiconductor device substrate. Meanwhile, component (A) and component (B) by themselves are insufficient in the effect of inhibiting the fine particles from adhering to the surface of the semiconductor device substrate. According to the cleaning liquid of the invention, since a polymeric coagulant is further contained therein as component (C), the fine particles which have become less apt to adhere to the surface of the semiconductor device substrate are coagulated to form fine-particle coagulation. Thus, adhesion thereof to the substrate surface is further reduced.

Processes for producing the cleaning liquid of the invention are not particularly limited, and the cleaning liquid may be produced by a conventionally known process. For example, the cleaning liquid can be produced by mixing ingredients for constituting the cleaning liquid (components (A) to (D) and other ingredients employed according to need).

The sequence of mixing also is not limited unless the mixing poses a particular problem such as, for example, reaction or precipitation. Use may be made of a method in which any two or more of the ingredients for constituting the cleaning liquid are mixed beforehand and the remaining ingredients are thereafter mixed therewith. Alternatively, all the ingredients may be mixed together at a time.

The cleaning liquid of the invention may be produced while regulating the concentrations of components (A) to (C) so as to be suitable for cleaning. However, there are often cases where a cleaning liquid which contains the components in high concentrations (hereinafter sometimes referred to as “cleaning liquid concentrate”) is first produced and is thereafter diluted with water as component (D) and used, from the standpoint of reducing the cost of transportation and storage.

There are no particular limitations on the concentration of each component in this cleaning liquid concentrate. It is, however, preferred that the concentration thereof should be within such a range that none of components (A) to (C), other ingredients added according to need, and any product of reaction between these ingredients separates out or precipitates in the cleaning liquid concentrate.

Such preferred ranges of the concentrations in the cleaning liquid concentrate are 5 to 30% by mass for component (A), 0.01 to 10% by mass for component (B), and 0.001 to 10% by mass for component (C). When the concentrations thereof are within such ranges, the components contained in the concentrate are less apt to separate out during transportation or storage and, by adding water thereto, the concentrate can be easily rendered usable as a suitable cleaning liquid having concentrations suitable for cleaning.

The concentration of each component in the cleaning liquid at the time when the cleaning liquid is used for cleaning a substrate for semiconductor devices (this cleaning liquid is hereinafter sometimes referred to as “diluted cleaning liquid” or “diluted solution”) is suitably determined according to the semiconductor device substrate to be cleaned.

The concentration of component (A), when the solution is used as a cleaning liquid, is generally 0.03 to 3% by mass, preferably 0.05 to 3% by mass, more preferably 0.06 to 1% by mass.

In case where the concentration of component (A) is less than 0.03% by mass, there is a possibility that contaminant removal from the substrate for semiconductor devices might be insufficient. Even when the concentration thereof exceeds 3% by mass, not only the effect thereof is not enhanced any more but also the removal of the cleaning liquid by water rinsing after the cleaning is costly. In addition, when the concentration of component (A) exceeds 3% by mass, there are cases where this cleaning liquid arouses a trouble that copper wiring corrosion occurs.

The cleaning liquid of the invention contains component (B), which is a surfactant, and component (C), which is a coagulant. Component (B), which is a sulfonic acid type anionic surfactant, has the effect of causing electrostatic repulsion between the substrate for semiconductor devices and fine particles and has the function of preventing the fine particles which have been separated from the substrate from adhering thereto again. Component (C), which is a coagulant, has the function of changing the dispersed state of the fine particles within the solution to coagulate the fine particles and increase the substantial particle diameter of the fine particles and thereby facilitating the removal thereof from the substrate for semiconductor devices.

From the standpoint of sufficiently obtaining the ability to remove fine-particle contaminants, the mass ratio of component (B) and component (C) [component (B)/component (C)] is usually preferably in the range of 1/15 to 1.5/1, more preferably in the range of 1/10 to 1/1, although the suitable range varies depending on the components used.

The concentration of component (B), when the solution is used as a cleaning liquid, is generally 0.0001 to 1% by mass, preferably 0.0001 to 0.3% by mass.

The concentration of component (C) is generally 0.000001 to 0.1% by mass. In the case where component (C) is polyvinylpyrrolidone, it is especially preferred that the concentration thereof should be 0.00001 to 0.003% by mass. In the case where component (C) is a polyethylene oxide-polypropylene oxide block copolymer, it is especially preferred that the concentration thereof should be 0.00001 to 0.03% by mass.

When the concentration of component (B), which is a sulfonic acid type anionic surfactant, is too low, there are cases where a sufficient decrease in zeta potential does not occur, resulting in insufficient electrostatic repulsion between the fine particles and the substrate for semiconductor devices. Conversely, even when the concentration of component (B) is too high, not only an improvement in effect which compensates for the concentration is not obtained but also use of this cleaning liquid results in excessive frothing and in an increase in the burden of waste liquid treatment.

Meanwhile, in case where the concentration of component (C), which is a coagulant, in the solution that is being used as a cleaning liquid is too low, the effect of coagulating fine particles is insufficient and there is hence a possibility that the fine particles cannot be sufficiently removed. Conversely, in case where the concentration thereof is too high, the cleaning liquid has an increased viscosity, resulting in a decrease in operation efficiency due to, for example, impaired cleaning liquid removability. In addition, an increase in the burden of waste liquid treatment results.

As stated above, the cleaning liquid to be subjected to cleaning may be produced by diluting a cleaning liquid concentrate so that the concentration of each component becomes suitable for the semiconductor device substrate to be cleaned, or may be directly produced while regulating the concentration of each component to such concentration.

By using the cleaning liquid in which colloidal silica has a negative value of zeta potential, fine particles such as, for example, colloidal silica can be prevented from adhering to the surface of the semiconductor device substrate.

The cleaning liquid of the invention employs component (B), which is a sulfonic acid type anionic surfactant, and component (C), which is a coagulant, in combination, and has thereby attained an improvement in cleaning effect.

In particular, when PVP and/or an EO/PO copolymer is used as component (C) in the cleaning liquid of the invention, this cleaning liquid can be made to satisfy the following: colloidal silica having a primary-particle diameter of 80 nm has a zeta potential of −20 mV or lower as measured in a liquid prepared by diluting the cleaning liquid to a water/cleaning liquid (cleaning liquid concentrate) ratio of 40 by mass. Incidentally, the colloidal silica to be used is spherical one. The primary-particle diameter thereof can be determined through an examination with an electron microscope. As such colloidal silica, use may be made, for example, of “Cataloid S” Series, manufactured by JGC Catalysts and Chemicals Ltd.

By regulating the zeta potential measured under those conditions to −20 mV or lower, electrostatic repulsion can be caused between the semiconductor device substrate and colloidal silica, making it possible to efficiently prevent fine colloidal silica particles from adhering to the semiconductor device substrate.

It is preferred that the cleaning liquid of the invention should have a pH of 5 or less in terms of the pH of the cleaning liquid which is being used (diluted cleaning liquid). The pH thereof is more preferably 1 to 4, especially preferably 1 to 3.

In case where the pH thereof exceeds 5, the cleaning effect of the organic acid is apt to be insufficient. The lower the pH thereof, the more the cleaning liquid is advantageous from the standpoint of cleaning. However, in case where the pH thereof is less than 1, there is the possibility of posing a problem concerning substrate corrosion.

The pH of the cleaning liquid of the invention can be regulated by regulating the addition amount of each component contained in the cleaning liquid.

The cleaning liquid of the invention may contain other ingredients in any desired proportions so long as the inclusion thereof does not impair the performance of the cleaning liquid.

Examples of the other ingredients include:

anticorrosives such as sulfur-containing organic compounds such as 2-mercaptothiazoline, 2-mercaptoimidazoline, 2-mercaptoethanol and thioglycerol,

nitrogen-containing organic compounds such as benzotriazole, 3-aminotriazole, N(R²)₃ (the R² groups are alkyl groups having 1 to 4 carbon atoms and/or hydroxyalkyl groups having 1 to 4 carbon atoms and may be the same or different), urea and thiourea,

water-soluble polymers such as polyethylene glycol and polyvinyl alcohol, and

alkylalcohol compounds such as R³OH (R³ is an alkyl group having 1 to 4 carbon atoms);

dissolved gases such as hydrogen, argon, nitrogen, carbon dioxide and ammonia;

etching accelerators which are expected to produce the effect of removing polymers and the like that are tenaciously adherent after dry etching, such as hydrofluoric acid, ammonium fluoride, and BHF (buffered hydrofluoric acid);

reducing agents such as hydrazine;

oxidizing agents such as hydrogen peroxide, ozone and oxygen; and

alkanolamines such as monoethanolamine, diethanolamine and triethanolamine.

Incidentally, there are cases where the semiconductor device substrate to be cleaned has, as wiring, an exposed metallic material, e.g., Cu, that reacts with hydrogen peroxide and dissolves. It is preferred that the cleaning liquid to be used for cleaning in this case should contain substantially no hydrogen peroxide.

The cleaning method of the invention is explained next.

The cleaning method of the invention is carried out by a method in which the cleaning liquid of the invention described above is brought into direct contact with a substrate for semiconductor devices.

Examples of the semiconductor device substrate to be cleaned include various semiconductor device substrates such as semiconductors, glasses, metals, ceramics, resins, magnetic materials and superconductors.

The cleaning liquid of the invention is especially suitable for a semiconductor device substrate, among those substrates, that has a metal or metal compound as wiring or the like in the surface thereof, because this cleaning liquid does not corrode the metal surface and can be removed by short-time rinsing.

Examples of the metal used in the semiconductor device substrate include W, Cu, Ti, Cr, Co, Zr, Hf, Mo, Ru, Au, Pt and Ag, and examples of the metal compound include nitrides, oxides and silicides of these metals. Of these, Cu and Cu-containing compounds are preferred.

Furthermore, since the cleaning method of the invention produces a high cleaning effect even on low-dielectric constant insulating materials having high hydrophobicity, this cleaning method is suitable also for semiconductor device substrates having a low-dielectric constant insulating material.

Examples of such low-dielectric constant materials include organic polymer materials such as polyimides, BCB (benzocyclobutene), Flare (Honeywell Inc.), and SiLK (Dow Chemical Co.), inorganic polymer materials such as FSG (Fluorinated silicate glass) and SiOC type materials such as BLACK DIAMOND (Applied Materials Inc.) and Aurora (ASM Japan K.K.).

The cleaning method of the invention is especially suitable for application to the case where the semiconductor device substrate has Cu wiring and a low-dielectric constant insulating film on the substrate surface and this substrate is subjected to a CMP treatment before being cleaned. In the CMP step, the substrate is polished with a polishing agent while rubbing the substrate against a pad.

The polishing agent includes abrasive particles such as colloidal silica (SiO₂), fumed silica (SiO₂), alumina (Al₂O₃) or ceria (CeO₂). Although such abrasive particles are a main cause of fine-particle contamination of the semiconductor device substrate, the cleaning liquid of the invention is highly effective against fine-particle contamination because this cleaning liquid has the functions of dispersing the fine particles adherent to the substrate in the cleaning liquid and preventing the dispersed fine particles from adhering again.

There are cases where the polishing agent contains additives other than abrasive particles, such as, for example, an oxidizing agent and a dispersant.

Especially in the CMP of a semiconductor device substrate which has a Cu film as metallic wiring on the surface thereof, an anticorrosive is often added because the Cu film is apt to be corroded.

As the anticorrosive, it is preferred to use an azole-based anticorrosive having a high anticorrosive effect. More specifically, examples thereof include diazole, triazole and tetrazole compounds which include a heterocycle that contains nitrogen alone as the only heteroatoms, oxazole, isoxazole and oxadiazole compounds which include a heterocycle that contains nitrogen and oxygen as the heteroatoms, and thiazole, isothiazole and thiadiazole compounds which include a heterocycle that contains nitrogen and sulfur as the heteroatoms. Especially preferred of these is a benzotriazole (BTA)-based anticorrosive, which has an excellent anticorrosive effect.

The cleaning liquid of the invention is excellent in that when applied to a surface which has been polished with a polishing agent containing such anticorrosives, the cleaning liquid can highly effectively remove contaminants attributable to the anticorrosives.

Namely, when such an anticorrosive is present in the polishing agent, the anticorrosive inhibits the Cu film surface from being corroded but reacts with Cu ions which have dissolved out during the polishing and thereby generates an insoluble deposit in a large amount. The cleaning liquid of the invention can efficiently dissolve and remove such insoluble deposits. In addition, the surfactant, which is apt to remain on the metal surface, can be removed by short-time rinsing. An improvement in throughput is hence possible.

Consequently, the cleaning method of the invention is suitable for the cleaning of a semiconductor device substrate which has a surface where a Cu film and a low-dielectric constant insulating film coexist and which has undergone a CMP treatment. In particular, this cleaning method is suitable for the cleaning of the substrate which has undergone a CMP treatment with a polishing agent containing an azole-based anticorrosive.

As stated above, the cleaning method of the invention is carried out by a method in which the cleaning liquid of the invention is brought into direct contact with a substrate for semiconductor devices. A cleaning liquid having suitable component concentrations is selected in accordance with the kind of the semiconductor device substrate to be cleaned.

For example, in the case where the semiconductor device substrate to be cleaned is a substrate which has Cu wiring and a low-dielectric constant insulating film on the substrate surface, suitable concentration ranges for the components are as follows. The concentration of component (A) is 0.03 to 3% by mass, preferably 0.06 to 1% by mass; the concentration of component (B) is 0.0001 to 1% by mass, preferably 0.0001 to 0.3% by mass; and the concentration of component (C) is 0.00001 to 0.1% by mass, preferably 0.0001 to 0.03% by mass. In the case where component (C) is polyvinylpyrrolidone, a suitable range of the concentration thereof is 0.00001 to 0.003% by mass. In the case where component (C) is a polyethylene oxide-polypropylene oxide block copolymer, a suitable range of the concentration thereof is 0.00001 to 0.03% by mass.

Examples of methods for bringing the cleaning liquid into contact with the substrate include a dipping method in which a cleaning tank is filled with the cleaning liquid and the substrate is dipped therein, a spinning method in which the substrate is rotated at a high speed while causing the cleaning liquid to flow onto the substrate from a nozzle, and a spraying method in which the liquid is sprayed on the substrate to clean the substrate. Examples of apparatus for conducting such cleaning include a batch cleaning apparatus in which a plurality of substrates held in a cassette are simultaneously cleaned and a sheet-by-sheet cleaning apparatus in which one substrate is attached to a holder and cleaned.

Although the cleaning liquid of the invention is applicable to any of those methods, it is preferred to use the cleaning liquid in cleaning by the spinning method or spraying method from the standpoint that contaminants can be more efficiently removed in a short period. When the cleaning liquid of the invention is applied to a sheet-by-sheet cleaning apparatus, in which a reduction in cleaning period and a reduction in cleaning liquid use amount are desired, these problems are eliminated. Use of the cleaning liquid in this apparatus is hence preferred.

When the cleaning method of the invention is conducted in combination with a method of cleaning based on physical force, in particular, with scrubbing with a cleaning brush or ultrasonic cleaning conducted at a frequency of 0.5 MHz or higher, the ability to eliminate the contamination due to fine particles adherent to the substrate is improved and this leads to a reduction in cleaning period. Use of this combination is hence preferred. Especially in cleaning after a CMP, it is preferred to conduct scrubbing with a resinous brush. Although the material of the resinous brush can be selected at will, it is preferred to use, for example, PVA (polyvinyl alcohol).

Furthermore, rinsing with water may be conducted before and/or after the cleaning performed by the cleaning method of the invention.

In the cleaning method of the invention, the temperature of the cleaning liquid may usually be room temperature. However, the cleaning liquid may be heated to about 40 to 70° C. so long as this heating does not impair the performance thereof.

### EXAMPLES

The invention will be explained below in more detail by reference to Examples, but the invention should not be construed as being limited to the following Examples unless the invention departs from the spirit thereof.

The reagents used for producing the cleaning liquids of the Examples and Comparative Examples are as follows.

### “Reagents”

Component (A): organic acid
   Citric acid (special-grade reagent; manufactured by Wako Pure Chemical Ltd.)
Component (B): sulfonic acid type anionic surfactant
   Dodecylbenzenesulfonic acid (abbreviation: DBS) (manufactured by Lion Corp.)
Component (C): polymeric coagulant
   Polyethylene oxide-polypropylene oxide block copolymer (abbreviation: EO/PO) (EPAN U-108, manufactured by Dai-ichi Kogyo Seiyaku Co., Ltd.)
   Polyvinylpyrrolidone (abbreviation: PVP) (PITZCOL K-30, manufactured by Dai-ichi Kogyo Seiyaku Co., Ltd.)
Component (C′): water-soluble polymer which is outside the range of component (C)
   Polyethylene glycol (abbreviation: PEG) (PEG 6000, manufactured by Dai-ichi Kogyo Seiyaku Co., Ltd.)
   Poly(acrylic acid) (abbreviation: PAA) (SHALLOL AN-103, manufactured by Dai-ichi Kogyo Seiyaku Co., Ltd.)
   Carboxymethyl cellulose sodium salt (abbreviation: CMC) (CELLOGEN F-6HS9, manufactured by Dai-ichi Kogyo Seiyaku Co., Ltd.)

### Example 1

(Preparation of Cleaning liquid)

Fifteen percent by mass citric acid as component (A), 0.5% by mass DBS as component (B), and 0.002% by mass EO/PO as component (C) were mixed with water as component (D) to prepare a semiconductor device substrate cleaning liquid concentrate of Example 1.

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

### (Evaluation of Coagulation Effect)

Colloidal silica (Cataloid SI-50P, manufactured by JGC Catalysts and Chemicals Ltd.) was added to 40 g of the cleaning liquid (diluted solution) so as to result in a concentration thereof of 0.005% by mass. This cleaning liquid was sufficiently stirred using a magnetic stirrer and then visually examined for turbidity. The results obtained are shown in Table 2.

### (Measurement of Zeta Potential)

Colloidal silica (Cataloid SI-80P, manufactured by JGC Catalysts and Chemicals Ltd.; primary-particle diameter, 80 nm) was added to the cleaning liquid (diluted solution) so as to result in a concentration of the colloidal silica of 0.008% by mass. This cleaning liquid (diluted solution) was stirred for 1 hour or longer using a magnetic stirrer, and a measurement was thereafter conducted using a zeta potential analyzer (ELS-6000; Otsuka Electronics Co., Ltd.). The measurement was made three times, and an average for these measurements was obtained as measurement results. The measurement results are shown in Table 2.

### Example 2

A semiconductor device substrate cleaning liquid concentrate of Example 2 was prepared in the same manner as in Example 1, except that 0.01% by mass EO/PO was used as component (C).

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

The cleaning liquid obtained was used to conduct the evaluation of coagulation effect and the measurement of zeta potential in the same manners as in Example 1. The results of the evaluation are shown in Table 2.

### Example 3

A semiconductor device substrate cleaning liquid concentrate of Example 3 was prepared in the same manner as in Example 1, except that 0.02% by mass EO/PO was used as component (C).

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

The cleaning liquid obtained was used to conduct the evaluation of coagulation effect and the measurement of zeta potential in the same manners as in Example 1. The results of the evaluation are shown in Table 2.

### Example 4

A semiconductor device substrate cleaning liquid concentrate of Example 4 was prepared in the same manner as in Example 1, except that 0.2% by mass EO/PO was used as component (C).

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

The cleaning liquid obtained was used to conduct the evaluation of coagulation effect and the measurement of zeta potential in the same manners as in Example 1. The results of the evaluation are shown in Table 2.

### Example 5

A semiconductor device substrate cleaning liquid concentrate of Example 5 was prepared in the same manner as in Example 1, except that 0.002% by mass PVP was used as component (C).

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

The cleaning liquid obtained was used to conduct the evaluation of coagulation effect and the measurement of zeta potential in the same manners as in Example 1. The results of the evaluation are shown in Table 2.

### Example 6

A semiconductor device substrate cleaning liquid concentrate of Example 6 was prepared in the same manner as in Example 1, except that 0.01% by mass PVP was used as component (C).

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

The cleaning liquid obtained was used to conduct the evaluation of coagulation effect and the measurement of zeta potential in the same manners as in Example 1. The results of the evaluation are shown in Table 2.

### Example 7

A semiconductor device substrate cleaning liquid concentrate of Example 7 was prepared in the same manner as in Example 1, except that 0.02% by mass PVP was used as component (C).

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

The cleaning liquid obtained was used to conduct the evaluation of coagulation effect and the measurement of zeta potential in the same manners as in Example 1. The results of the evaluation are shown in Table 2.

### Comparative Example 1

Component (C) was omitted. Fifteen percent by mass citric acid as component (A) and 0.5% by mass DBS as component (B) were mixed with water as component (D) to prepare a semiconductor device substrate cleaning liquid concentrate of Comparative Example 1, which had the composition shown in Table 1.

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

The cleaning liquid obtained was used to conduct the evaluation of coagulation effect and the measurement of zeta potential in the same manners as in Example 1. The results of the evaluation are shown in Table 2.

### Comparative Example 2

A semiconductor device substrate cleaning liquid concentrate of Comparative Example 2 was prepared in the same manner as in Example 1, except that 0.002% by mass PEG was added as component (C′) in place of the component (C).

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

The cleaning liquid obtained was used to conduct the evaluation of coagulation effect and the measurement of zeta potential in the same manners as in Example 1. The results of the evaluation are shown in Table 2.

### Comparative Example 3

A semiconductor device substrate cleaning liquid concentrate of Comparative Example 3 was prepared in the same manner as in Example 1, except that 0.02% by mass PEG was added as component (C′) in place of the component (C).

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

The cleaning liquid obtained was used to conduct the evaluation of coagulation effect and the measurement of zeta potential in the same manners as in Example 1. The results of the evaluation are shown in Table 2.

### Comparative Example 4

A semiconductor device substrate cleaning liquid concentrate of Comparative Example 4 was prepared in the same manner as in Example 1, except that 0.2% by mass PEG was added as component (C′) in place of the component (C).

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

The cleaning liquid obtained was used to conduct the evaluation of coagulation effect and the measurement of zeta potential in the same manners as in Example 1. The results of the evaluation are shown in Table 2.

### Comparative Example 5

A semiconductor device substrate cleaning liquid concentrate of Comparative Example 5 was prepared in the same manner as in Example 1, except that 0.02% by mass PAA was added as component (C′) in place of the component (C).

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

The cleaning liquid obtained was used to conduct the evaluation of coagulation effect and the measurement of zeta potential in the same manners as in Example 1. The results of the evaluation are shown in Table 2.

### Comparative Example 6

A semiconductor device substrate cleaning liquid concentrate of Comparative Example 6 was prepared in the same manner as in Example 1, except that 0.2% by mass PAA was added as component (C′) in place of the component (C).

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

The cleaning liquid obtained was used to conduct the evaluation of coagulation effect and the measurement of zeta potential in the same manners as in Example 1. The results of the evaluation are shown in Table 2.

### Comparative Example 7

A semiconductor device substrate cleaning liquid concentrate of Comparative Example 7 was prepared in the same manner as in Example 1, except that 2% by mass PAA was added as component (C′) in place of the component (C).

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

The cleaning liquid obtained was used to conduct the evaluation of coagulation effect in the same manners as in Example 1. The results of the evaluation are shown in Table 2.

### Comparative Example 8

A semiconductor device substrate cleaning liquid concentrate of Comparative Example 8 was prepared in the same manner as in Example 1, except that 0.2% by mass CMC was added as component (C′) in place of the component (C).

Subsequently, water was added to the cleaning liquid concentrate so as to result in a water/cleaning liquid concentrate mass ratio of 40. Thus, a cleaning liquid (diluted solution) for semiconductor device substrates was prepared. The compositions of the cleaning liquid concentrate and diluted solution are shown in Table 1.

The cleaning liquid obtained was used to conduct the evaluation of coagulation effect in the same manners as in Example 1. The results of the evaluation are shown in Table 2.

TABLE 1

| | Composition of cleaning liquid | | | | | | |
|---|---|---|---|---|---|---|---|
| | Component (A): | | Component (B): | | | | |
| | citric acid | | DBS | | Component (C) | | |
| | (mass %) | | (mass %) | | (mass %) | | |
| | | Diluted | | Diluted | | | Diluted |
| | Concentrate | solution | Concentrate | solution | Kind | Concentrate | solution |
| Example 1 | 15 | 0.375 | 0.5 | 0.0125 | EO/PO | 0.002 | 0.00005 |
| Example 2 | 15 | 0.375 | 0.5 | 0.0125 | EO/PO | 0.01 | 0.00025 |
| Example 3 | 15 | 0.375 | 0.5 | 0.0125 | EO/PO | 0.02 | 0.0005 |
| Example 4 | 15 | 0.375 | 0.5 | 0.0125 | EO/PO | 0.2 | 0.005 |
| Example 5 | 15 | 0.375 | 0.5 | 0.0125 | PVP | 0.002 | 0.00005 |
| Example 6 | 15 | 0.375 | 0.5 | 0.0125 | PVP | 0.01 | 0.00025 |
| Example 7 | 15 | 0.375 | 0.5 | 0.0125 | PVP | 0.02 | 0.0005 |
| Comparative | 15 | 0.375 | 0.5 | 0.0125 | — | — | — |
| Example 1 | | | | | | | |
| Comparative | 15 | 0.375 | 0.5 | 0.0125 | PEG* | 0.002 | 0.00005 |
| Example 2 | | | | | | | |
| Comparative | 15 | 0.375 | 0.5 | 0.0125 | PEG* | 0.02 | 0.0005 |
| Example 3 | | | | | | | |
| Comparative | 15 | 0.375 | 0.5 | 0.0125 | PEG* | 0.2 | 0.005 |
| Example 4 | | | | | | | |
| Comparative | 15 | 0.375 | 0.5 | 0.0125 | PAA* | 0.02 | 0.0005 |
| Example 5 | | | | | | | |
| Comparative | 15 | 0.375 | 0.5 | 0.0125 | PAA* | 0.2 | 0.005 |
| Example 6 | | | | | | | |
| Comparative | 15 | 0.375 | 0.5 | 0.0125 | PAA* | 2 | 0.05 |
| Example 7 | | | | | | | |
| Comparative | 15 | 0.375 | 0.5 | 0.0125 | CMC* | 0.2 | 0.005 |
| Example 8 | | | | | | | |

*PEG, PAA and CMC are water-soluble polymers outside the range of component (C).

TABLE 2

| | | Zeta |
|---|---|---|
| | | potential |
| | Coagulation effect | (mV) |
| Example 1 | white turbidity | −29 |
| Example 2 | white turbidity | −34 |
| Example 3 | precipitation | −28 |
| Example 4 | precipitation | −21 |
| Example 5 | white turbidity | −20 |
| Example 6 | white turbidity | −22 |
| Example 7 | white turbidity | −26 |
| Comparative Example 1 | no change | −18 |
| Comparative Example 2 | white turbidity | −17 |
| Comparative Example 3 | precipitation | −18 |
| Comparative Example 4 | precipitation | −15 |
| Comparative Example 5 | no change | −18 |
| Comparative Example 6 | no change | −15 |
| Comparative Example 7 | no change | — |
| Comparative Example 8 | no change | — |

In Table 2, the zeta potential (unit: mV) is an index to the force of repulsion between the substrate and the particles which have separated from the substrate during cleaning. The larger the minus absolute value thereof, the higher the force of repulsion.

Below −30 mV: The repulsion force is exceedingly high.

−30 mV or higher but −20 mV or lower: The repulsion force is high and the particles can be prevented from adhering again.

Higher than −20 mV: The effect of component (C) is not exhibited.

While the invention has been described in detail and with reference to specific embodiments thereof, it will be apparent to one skilled in the art that various changes and modifications can be made therein without departing from the spirit and scope thereof. This application is based on a Japanese patent application filed on Oct. 1, 2010 (Application No. 2010-224124), the contents thereof being incorporated herein by reference.

### INDUSTRIAL APPLICABILITY

The cleaning liquid for semiconductor device substrates of the invention is capable of simultaneously removing the fine particles, organic contaminants, and metallic contaminants which are adherent to a semiconductor device substrate, without corroding the substrate surface, and has satisfactory water rinsability. Therefore, the invention is exceedingly useful industrially as a technique for cleaning contaminated semiconductor device substrates in steps for producing semiconductor devices, display devices, etc.

1. A cleaning liquid for semiconductor device substrates, which is for use in a step of cleaning a semiconductor device substrate to be conducted after a chemical mechanical polishing step in semiconductor device production, the cleaning liquid comprising the following components (A) to (D):
(A) an organic acid;
(B) a sulfonic acid type anionic surfactant;
(C) at least one polymeric coagulant selected from polyvinylpyrrolidone and polyethylene oxide-polypropylene oxide block copolymers; and
(D) water.

2. The cleaning liquid for semiconductor device substrates according to claim 1,
wherein component (A) is an organic acid having 1 to 10 carbon atoms and one or more carboxyl groups.

3. The cleaning liquid for semiconductor device substrates according to claim 2,
wherein component (A) is at least one member selected from the group consisting of oxalic acid, citric acid, tartaric acid, malic acid, lactic acid, ascorbic acid, gallic acid and acetic acid.

4. The cleaning liquid for semiconductor device substrates according to claim 1,
wherein component (B) is at least one member selected from the group consisting of alkylsulfonic acids and salts thereof, alkylbenzenesulfonic acids and salts thereof, alkyldiphenyl ether disulfonic acids and salts thereof, alkylmethyltauric acids and salts thereof, and sulfosuccinic acid diesters and salts thereof.

5. The cleaning liquid for semiconductor device substrates according to claim 1,
wherein component (A) is contained in a concentration of 5 to 30% by mass,
component (B) is contained in a concentration of 0.01 to 10% by mass, and
component (C) is contained in a concentration of 0.001 to 10% by mass.

6. The cleaning liquid for semiconductor device substrates according to claim 1,
wherein component (C) is polyvinylpyrrolidone,
component (A) is contained in a concentration of 0.03 to 3% by mass,
component (B) is contained in a concentration of 0.0001 to 1% by mass, and
component (C) is contained in a concentration of 0.00001 to 0.003% by mass.

7. The cleaning liquid for semiconductor device substrates according to claim 1,
wherein component (C) is a polyethylene oxide-polypropylene oxide block copolymer,
component (A) is contained in a concentration of 0.03 to 3% by mass,
component (B) is contained in a concentration of 0.0001 to 1% by mass, and
component (C) is contained in a concentration of 0.00001 to 0.03% by mass.

8. The cleaning liquid for semiconductor device substrates according to claim 1,
wherein colloidal silica having a primary-particle diameter of 80 nm has a zeta potential of −20 mV or lower as measured in a liquid prepared by diluting the cleaning liquid to a water/cleaning liquid ratio of 40 by mass.

9. A method of cleaning a substrate for semiconductor devices, comprising:
cleaning the substrate for semiconductor devices by using the cleaning liquid for semiconductor device substrates according to claim 1.

10. The method of cleaning a substrate for semiconductor devices according to claim 9,
wherein the substrate for semiconductor devices has Cu wiring and a low-dielectric constant insulating film on a substrate surface, and
the substrate for semiconductor devices that has been subjected to chemical mechanical polishing is cleaned.
